(19) United States
(12) Patent Application Publication
(10) Pub. No.: US 2002/0107304 A1
(43) Pub. Date: Aug. 8, 2002

(54) Thermochromic ink compositions for an ink jet printer

(75) Inventors: Yi-Jing Leu, Hsinchu (TW); In-Shan Sir, Kaohsiung (TW); Yu-Chang Shen, Taipei (TW); Chia-Hsin Chien, Taoyuan Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: BENO Corporation

(21) Appl. No.: 10/057,056

(22) Filed: Jan. 25, 2002

(30) Foreign Application Priority Data
Feb. 2, 2001 (TW) 90102165

(51) Int. Cl. C09D 11/00; G01D 11/00; C08K 9/00

(52) U.S. Cl. 523/160; 347/100; 106/31.6; 523/205

(57) ABSTRACT

The present invention provides a thermochromic ink composition for an ink jet printer comprising at least one thermochromic pigment and a carrier medium. The thermochromic pigment is encapsulated to form a thermochromic micro-encapsule pigment whose particle size is below 1 μm and temperature of coloration/decoloration is −10˜100° C. The carrier medium is a water solution or an organic solution with surfactant, dispersant, buffer, chelating agent, bactericide, preservative, and UV inhibitor.

### BACKGROUND OF THE INVENTION

1. Field of the Invention

The present invention relates in general to a thermochromic ink composition for an ink jet printer. In particular, the present invention relates to an ink composition with thermochromic micro-encapsule pigments for the ink jet printer.

2. Description of the Related Art

Ink jet printing is a non-impact method for producing images by the deposition of ink droplets in a pixel-by-pixel manner to an image-recording element in response to digital signals. The ink used in the ink jet printer nowadays turns into color ink from simple black ink used before.

In general, four color inks which comprise magenta ink, cyan ink, yellow ink, and black ink are basically used to create ink dots and print an image by a color ink jet printer. Recently, six color inks comprising magenta ink, cyan ink, yellow ink, black ink, light magenta ink, and light cyan ink or seven color inks with further comprising light yellow ink, light black ink, orange ink, blue ink and red ink are used. These color inks comprise water-soluble dye or pigments, water, organic solvent, and other additives. However, when these water-soluble dye-based inks are printed on an image-recording media, the resultant image has poor water-fastness and light-fastness, so that it is easily dispersed by water and discolored under long lighting.

Therefore, a mass of pigment-based inks with good water-fastness and light-fastness are developed. The pigment-based inks have better water-fastness and light-fastness than water-soluble dye-based inks. However, with the progress of technologies, there are higher demands for quality and result of printing. The image with simple and constant color picture cannot satisfy people' request in pursuit of the dynamic vision variation gradually.

### SUMMARY OF THE INVENTION

It is an object of this invention to provide an ink jet composition with thermochromic pigment and apply it to color ink jet printing to improve quality of printing, light-fastness, and heat stability. Moreover, the colors of the image can change with ambient temperature so that the image can have dynamic colors and aplenty color vision.

The present invention provides a thermochromic ink composition comprising at least one thermochromic pigment and a carrier medium for the ink jet printer.

The above-mentioned thermochromic pigment is encapsulated to form a thermochromic micro-encapsule pigment whose particle size is below 1 μm and the temperature of coloration/ decoloration is within the range of −10˜100° C. The carrier medium is a water or organic solution with surfactant, dispersant, buffer, chelating agent, bactericide, preservative, and UV inhibitor. If the carrier medium is a water solution, the composited ink is a water-soluble ink and the content of water based on the whole ink composition is about 65˜90 wt. %. If the carrier medium is an organic solution, the composited ink is an organic solvent-soluble ink and the content of organic solvent based on the whole ink composition is about 50˜95 wt. %.

The present invention also provides a method of ink jet printing, comprising: (a) providing a thermochromic ink jet printing ink containing at least one thermochromic micro-encapsule pigment and a carrier medium; and (b) depositing the thermochromic ink on a recording medium.

### DETAILED DESCRIPTION OF THE PREFERRED EMBODIMENT

In order to get a pattern whose colors changing with temperature to show dynamic colors and aplenty color vision, the thermochromic pigments are commonly used as the main component of the ink composition for the ink jet printer. The thermochromic pigments are encapsulated by resin to form thermochromic micro-encapsule pigments. The particle size of the thermochromic micro-encapsule pigments varies from between 10˜20 μm which is too large for ink jet printer's usage. Furthermore, the surface properties of such thermochromic pigments are different from the common pigments. They could lose their color variation characteristics if they are polished to a smaller size. In this invention, the thermochromic pigments are encapsulated to form micro-encapsule pigments. The particle size of the micro-encapsule pigments is controlled below 1 μm to prevent from blocking of the inkjet printer nozzles. The color of the thermochromic micro-encapsule pigments can change based on the temperature. The color variation (either from a specific color to another color or colorless or from colorless to a specific color) upon the temperature change is a reversible reaction and occurs during an effective time.

The thermochromic ink composition for the ink jet printer comprises at least one thermochromic pigment and a carrier medium.

The above-mentioned thermochromic pigment is, such as, disclosed in U.S. Pat Nos. 4,421,560 and 4,424,161. Their temperature of coloration/decoloration is about from −10° C. to 100° C. In one embodiment of this invention, we can mix the colorless thermochromic micro-encapsule pigments of different color variation temperatures in different ratios, or mix with common pigments to create ink dots on the recording medium, such as paper. Then an image with more changeable colors under different temperatures is to be got. For example, blue thermochromic micro-encapsule pigments whose color variation temperature is 0° C. after printing, red thermochromic micro-encapsule pigments whose color variation temperature is 30° C., and yellow thermochromic micro-encapsule pigments whose color variation temperature is 65° C. are mixed and deposited on the recording medium to form black pixels. When the temperature drops to 0° C., the color of the blue thermochromic micro-encapsule pigments turns into colorless, so the pixels show orange. When the temperature rises to 30° C., the blue and red thermochromic micro-encapsule pigments turn into colorless, so the pixels show yellow only.

The solid passivation film of the thermochromic micro-encapsule pigment is a firm and heat-resistant resin. The specific examples of such resin are acrylic resin, acrylonitrile-butadiene-styrene resin (ABS), acetal resin, polyethylene terephthalate (PET), polyamide, vinyl chloride resin, polycarbonate, polyphenylene oxide, polybutylene terephthalate, polyimide, polyethylene, polypropylene, polystyrene, and the like. Wherein, the acetal resin can be monomer polymer, or copolymer, and polyamide can be nylon-6 or nylon-66.

The carrier medium can be a water solution or an organic solution, containing surfactant (s), dispersant (s), buffer(s), chelating agent(s), bactericide(s), preservative(s), and UV inhibitor (s) If the carrier medium is a water solution to form a water-soluble ink for the ink jet printing, the content of water based on the whole ink composition is 65˜90 wt. %. If the carrier medium is an organic solution to form an organic solvent-soluble ink for the ink jet printing, the content of organic solvent based on the whole ink composition is 50˜95 wt. %.

The organic solvent used in the organic solvent-soluble ink can be cyclohexane, methanol, ethanol, ethylene glycol, diethylene glycol, triethylene glycol, polyethylene glycol, propylene glycol, butylene glycol, pentylene glycol, hexylene glycol, or other polyol.

The surfactant can be polybutyl resin, cellulose derivative, styrene/acrylic copolymer resin, maleic acid/styrene copolymer, other polymer with hydrophilic segment and hydrophobic segment, or their combinations. The content of the surfactant based on the whole ink composition is about 1˜20 wt. %.

The buffer can be diethanolamine, triethanolamine, hydroxides of alkali metals, ammonium hydroxide, carbonates of alkali metals, or their combinations. The specific examples of the hydroxides of alkali metals are lithium hydroxide, sodium hydroxide, and potassium hydroxide. The specific examples of the carbonates of alkali metals are lithium carbonate, sodium carbonate, and potassium carbonate.

The chelating agent can be sodium ethylenediamine-tetraacetate, trisodium nitrilotriacetate, hydroxyethyl ethylenediamine tridodium acetate, diethylenetriamino pentasodium acetate, uramil disodium acetate, or their combinations.

The UV inhibitor can be the following formula (I) (II) , or their combinations, wherein Y can be H or Na. The UV inhibitor can make the thermochromic ink composition have better light-fastness and reduce the decomposition of the thermochromic micro-encapsule pigments. Hence, the result picture can free from discoloration.

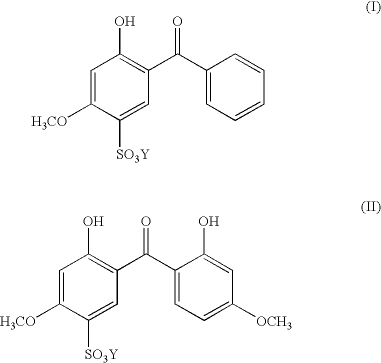

the above-mentioned thermochromic ink composition is applied to ink jet printing. The ink jet printer filled with thermochromic micro-encapsule pigments in the ink reservoirs deposits on the recording medium pixel-by-pixel to formapicture, and the picture can show different vision under different ambient temperature. Therefore, the picture shows changeable color variation and the thermochromic ink for the ink jet printer could be a fashion trend.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A thermochromic ink composition for an ink jet printer, comprising:
at least one thermochromic pigment; and
a carrier medium.

2. The composition as claimed in claim 1, wherein the temperature range of coloration/decoloration of the thermochromic pigment is within −10° C. to 100° C.

3. The composition as claimed in claim 1, wherein the thermochromic pigment is encapsulated to form a thermochromic micro-encapsule pigment, the particle size of the thermochromic micro-encapsule pigment is below 1 μm.

4. The composition as claimed in claim 3, wherein the content of the thermochromic pigment based on the whole ink composition is 0.1˜30 wt. %.

5. The composition as claimed in claim 1, wherein the carrier medium is a water solution.

6. The composition as claimed in claim 5, wherein the content of the water based on the whole composition is 65˜90 wt. %.

7. The composition as claimed in claim 1, wherein the carrier medium is an organic solution.

8. The composition as claimed in claim 7, wherein the content of the organic solvent is 50˜95%.

9. The composition as claimed in claim 7, wherein the organic solvent is selected from the group consisting of cyclohexane, methanol, ethanol, ethylene glycol, diethylene glycol, triethylene glycol, polyethylene glycol, propylene glycol, butylene glycol, pentylene glycol, hexylene glycol, other polyol, and their combinations.

10. The composition as claimed in claim 1, wherein the carrier medium comprises surfactant, dispersant, buffer, chelating agent, bactericide, preservative, and UV inhibitor.

11. The composition as claimed in claim 10, wherein the UV inhibitor is selected from the group consisting of the following formula (I), (II), and their combinations, wherein Y is selected from the group consisting of H and Na.

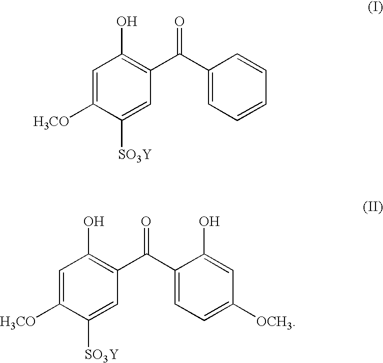

12. The composition as claimed in claim 10, wherein the content of the surfactant based on the whole ink composition is 1˜20 wt. %.

13. The composition as claimed in claim 10, wherein the surfactant is selected from the group consisting of polybutyl resin, cellulose derivative, styrene/acrylic copolymer resin, maleic acid/styrene copolymer, other polymer with hydrophilic segment and hydrophobic segment, and their combinations.

14. The composition as claimed in claim 10, wherein the buffer is selected from the group consisting of diethanolamine, triethanolamine, hydroxides of alkali metals, ammonium hydroxide, carbonates of alkali metals, and their combinations.

15. The composition as claimed in claim 10, wherein the chelating agent is selected from the group consisting of sodium ethylenediaminetetraacetate, trisodium nitrilotriacetate, hydroxyethyl ethylenediamine tridodium acetate, diethylenetriamino pentasodium acetate, uramil disodium acetate, and their combinations.

16. A method of ink jet printing, comprising:
(a) providing a thermochromic ink composition, containing at least one thermochromic micro-encapsule pigment and a carrier medium; and
(b) depositing the thermochromic ink on a recording medium pixel-by-pixel.

17. The method as claimed in claim 16, wherein the temperature of coloration/decoloration of the thermochromic micro-encapsule pigment is from −10° C. to 100° C.

18. The method as claimed in claim 16, wherein the particle size of the thermochromic micro-encapsule pigment is below 1 μm, and the content of the thermochromic pigment based on the whole ink composition is 0.1˜30 wt. %.

19. The method as claimed in claim 16, wherein the carrier medium is a water solution.

20. The method as claimed in claim 19, wherein the content of the water based on the whole composition is 65˜90 wt. %.

21. The method as claimed in claim 16, wherein the carrier medium is an organic solution.

22. The method as claimed in claim 21, wherein the content of the organic solvent is 50˜95 wt. %.

23. The method as claimed in claim 16, wherein the carrier medium comprises surfactant, dispersant, buffer, chelating agent, bactericide, preservative, and UV inhibitor.

24. The method as claimed in claim 23, wherein the UV inhibitor is selected from the group consisting of the following formula (I), (II), and their combinations, wherein Y is selected from the group consisting of H and Na.

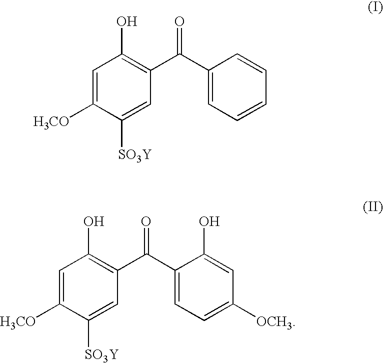

25. The method as claimed in claim 23, wherein the content of the surfactant based on the whole ink composition is 1˜20 wt. %.
